(19) United States
(12) Patent Application Publication
(10) Pub. No.: US 2005/0230989 A1
(43) Pub. Date: Oct. 20, 2005

(54) Wall slide

(75) Inventor: Michael W. Nebel, Smith Center, KS (US)

Correspondence Address: DARBY & DARBY P.C., P. O. BOX 5257, NEW YORK, NY, 10150-5257, US

(73) Assignee: Lippert Components, Inc.

(21) Appl. No.: 10/828,926

(22) Filed: Apr. 20, 2004

(51) Int. Cl. B62D 25/00

(52) U.S. Cl. 296/26.01

(57) ABSTRACT

According to one aspect, a slide-out mechanism for controllably moving a slide-out section that is associated with a vehicle, such as a recreational vehicle, is provided. The slide-out mechanism generally includes a pair of first guide members that are operatively coupled to the slide-out section, with each of the first guide members having a plurality of first drive features formed as a part thereof. The slide-out mechanism also includes a drive mechanism having a pair of first drive members that complement and engage the first drive features for controllably moving the slide-out section between a retracted position and an extended position as the first drive members successively engage the first drive features under action of the drive mechanism, thereby driving the first guide members and the slide-out section coupled thereto.

### TECHNICAL FIELD

The present invention relates to vehicles with one or more moveable room sections, and more particularly, relates to a slide-out mechanism that moves the moveable room section in a controlled manner from a retracted position relative to a main housing of the vehicle to an extended position where the moveable room protrudes beyond the main housing.

### BACKGROUND

Conventional recreational vehicles (RV) are available in a number of different types depending upon the size requirements and other desires of the purchaser. For example, the purchaser or user can select an RV that is motorized and can be driven by itself or one can be selected that requires a tow vehicle to tow the RV. Consumers increasingly want additional, increased interior room and also want to be provided with additional options available with the RV. One option that has found increasing commonality in the recent years is the incorporation of one or more slide-out sections into the RV. The incorporation of a slide-out section in the upper deck portion is desirable since it results in an increase in the available space for use as a living area. The slide-out sections are part of an automated or manual system where the user simply activates or manually actuates the system resulting in the slide-out section extending outward from a rear wall of the RV. The slide-out section in its extended position thus increases the overall available interior space. Slide-out sections can be incorporated into any number of different types of RVs including motor homes and fifth wheel trailer type RVs.

Conventional recreational vehicles typically include slide-out mechanisms with one or two arms that are the drive means for driving the slide-out section. However, slide-out mechanisms including only one arm provide limited support and are less stable. For slide-out mechanisms that include multiple arms, the movement of the arms must be synchronized. Arms that are not synchronized cause the slide-out section to be misaligned during extension thereof which can damage the slide-out mechanism and spoil the outward appearance of the vehicle.

Typical slide-out mechanisms in conventional recreational vehicles have a pre-set width. However, since slide-out sections can be constructed in varying sizes, the width of the slide-out mechanism is often too narrow or too wide. If the slide-out mechanism is too wide, it cannot be incorporated into narrower slide-out sections, and if the slide-out section is too narrow, the difference in width determines the amount of wasted, unutilized space for the slide-out section.

Furthermore, typical slide-out mechanisms in conventional recreational vehicles push the slide-out section at the bottom, i.e., the floor, of the slide-out section, and not at the top, i.e., the ceiling, of the slide-out section. These typical slide-out mechanisms that push the slide-out section only at the bottom provide limited support to the entire slide-out section and are less stable since the slide-out mechanism can become stuck at the interface between the ceiling of the slide-out section and the ceiling of the main housing of the recreational vehicle, which could also cause the slide-out section to be misaligned.

### SUMMARY

According to one aspect, a slide-out mechanism for controllably moving a slide-out section that is associated with a vehicle, such as a recreational vehicle, is provided. The slide-out mechanism generally includes a pair of first guide members that are operatively coupled to the slide-out section, with each of the first guide members having a plurality of first drive features formed as a part thereof. The slide-out mechanism also includes a drive mechanism having a pair of first drive members that complement and engage the first drive features for controllably moving the slide-out section between a retracted position and an extended position as the first drive members engage successive first drive features under action of the drive mechanism, thereby driving the first guide members and the slide-out section coupled thereto.

In one embodiment, each of the first guide members is in the form of an elongated bracket having one face that includes a recessed floor section formed between a pair of planar land sections that lie flush against a wall of the slide-out section. The first drive features are preferably formed in the recessed floor section. The first guide member can be in the form of an L-shaped bracket with a horizontal section being disposed against the underside of the floor and a vertical section is disposed against a side wall of the slide-out section.

The mechanism can further include a pair of second guide members that are disposed on an outer surface of a pair of opposite side walls of the slide-out section. Each second guide member has a plurality of second drive feature formed therein which cooperate with the drive mechanism such that actuation of the drive mechanism causes the second guide members to be driven with the first guide members, thereby driving the slide-out section. In one embodiment, each of the second guide members is in the form of a guide track that is securely coupled to one side wall of the slide-out section and the second drive features comprise a plurality of slots formed linearly along one face thereof.

According to one embodiment, the drive mechanism includes (a) a transverse drive shaft with one of the first drive members being proximate one end of the transverse drive shaft and the other first drive member being proximate the other end of the transverse drive shaft; (b) a pair of first coupling gears disposed at the first and second ends of the transverse drive shaft; (c) a pair of vertical drive shafts disposed at the first and second ends of the transverse drive shaft, with each vertical drive shaft including a second coupling gear that mates with one first coupling gear so that rotation of the transverse drive shaft is translated into rotation of the vertical drive shaft; and (d) a pair of second drive members coupled to the vertical drive shafts and operatively engaging second guide members that are securely mounted to side walls of the slide-out section such that rotation of the vertical drive shafts is translated into axial movement of the second guide members resulting in the slide-out section being moved. Preferably, the first and second drive members are in the form of rotatable toothed sprockets or gears that engage the corresponding drive features which are in the form of slots or ribs that are spaced apart so as to permit the sprocket to engage successive drive features to cause movement of the respective guide member.

The present slide-out mechanism overcomes the deficiencies of conventional mechanisms by providing a mechanism that drives the slide-out section in a smooth, uniform, even manner and can be constructed to accommodate variable width slide-out sections.

Further aspects and features of the present invention can be appreciated from the appended Figures and the accompanying written description.

### BRIEF DESCRIPTION OF THE DRAWINGS

The foregoing and other features of the present invention will be more readily apparent from the following detailed description and drawings of the illustrative embodiments of the invention wherein like reference numbers refer to similar elements and in which:

FIG. 1 is a perspective view of an RV with a slide-out section and a slide-out mechanism according to an embodiment of the present invention;

FIG. 2 is a sectional view taken along line 2 of FIG. 1 of a upper track mounted to the slide-out section;

FIG. 3 is a sectional view taken along line 3 of FIG. 1 of a lower track mounted to the slide-out section;

FIG. 4 is a perspective view of an interior of the RV of FIG. 1 with the slide-out section in a retracted position;

FIG. 5 is a perspective view of an interior of the RV of FIG. 1 with the slide-out section in an extended position;

FIG. 6 is a exploded perspective view of the slide-out mechanism and the interior of the RV of FIG. 1 with the slide-out section in the extended position;

FIG. 7 is an enlarged perspective view of the slide-out mechanism mounted to the slide-out section of FIG. 1;

FIG. 8 is a sectional view taken along the line 8 of FIG. 6 of the bottom gear assembly of the slide-out mechanism;

FIG. 9 is a sectional view taken along the line 9 of FIG. 6 of the upper gear assembly of the slide-out mechanism;

FIG. 10 is a sectional view taken along the line 10 of FIG. 5 of the bottom gear assembly and a hand crank of a slide-out mechanism; and

FIG. 11 is a perspective view of a sleeper box on a truck tractor with a slide-out section in an extended position, according to another embodiment of the present invention.

### DETAILED DESCRIPTION OF PREFERRED EMBODIMENTS

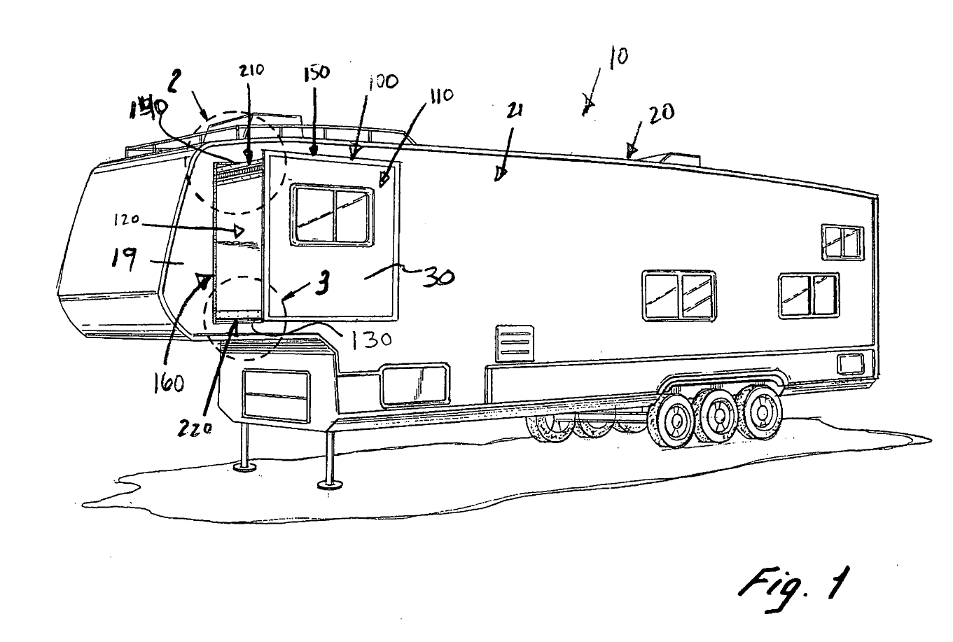

FIG. 1 is a perspective view of one exemplary recreational vehicle (RV) 10. There are a number of different types of RVs 10 that are available to a user depending upon a particular individual's needs, desires and wishes. For example, one type of RV is a motor home that is a self-contained motorized RV that looks something like a bus and is often referred to as a “coach”. This type of RV includes a number of different rooms and amenities that can provide superior comfort. Another type of RV is a travel trailer that is designed to be towed by a vehicle having hitch equipment for securely mating with the frame of the tow vehicle. Yet another type of RV is called a fifth wheel trailer (often referred to as a “fifth wheel”) which is a trailer that is designed to be towed by a vehicle, such as a pickup truck, that is equipped with a special hitch in a bed portion of the tow vehicle.

FIG. 1 illustrates a fifth wheel type RV 10; however, it will be understood that the present invention is not limited to this type of RV but rather it can be incorporated into other types of RVs, including those mentioned above. The RV 10 includes a main cabin or housing 20, which extends completely to the rear of the RV 10 and typically includes rooms, such as a master bedroom, kitchen, bathroom, closets, etc. A door (not shown) for entering the interior of the main cabin 20 is provided in this section. When the RV 10 is a fifth wheel type vehicle, as shown in FIG. 1, it includes an upper deck section 19 formed at one end of the main cabin 20 closest to the tow vehicle.

In most, if not all, of the RVs mentioned above, one or more slide-out sections 100 can be provided which, when extended, provide an increased amount of interior space. FIG. 1 illustrates the slide-out section 100 as an extension of a closet 30 that is extendable from the main cabin 20; however, it will be understood that the present invention is not limited to closets but rather it can be incorporated into other rooms of the RV 10, including those mentioned above. For example, the slide-out section 100 can be in the form of a room extension in that when placed in its extended position, the slide-out section 100 serves to merely extend the usable dimensions of the room in which the slide-out section 100 is incorporated.

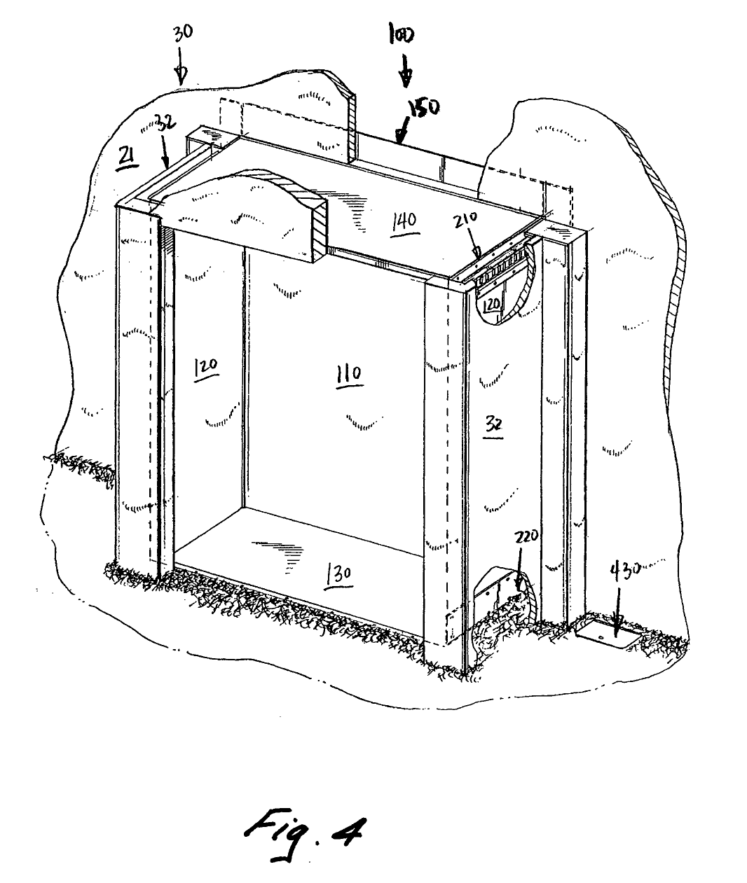

The exemplary RV 10 of FIG. 1 has at least one slide-out section 100 which is controllably movable from a retracted position (FIG. 4) to an extended position (shown in FIG. 1) for the purpose of increasing the available interior space of the RV 10. By actuating a slide-out mechanism 200, described in greater detail hereinafter, the slide-out section 100 can be extended away from a surrounding exterior wall 21 of the main cabin 20 and more particularly, an exterior wall 110 of the slide-out section 100 which is generally sealingly flush against exterior wall 21 in the retracted position is moved a distance thereaway in the extended position. As shown in FIG. 1, the slide-out section 100 contains not only the exterior wall 110 but also has a pair of side walls 120 as well as a roof section 130.

In order to provide a seal against the elements in both the retracted and extended positions, a skirt 150 can be and is preferably provided around the exterior wall 110 of the slide-out section 100, and a seal element 160 can be provided around the opening formed in the surrounding exterior wall 21 that permits the extension and retraction of the slide-out section 100 by permitting the slide-out section 100 to freely pass therethrough. When the slide-out section 100 is retracted, the skirt 150 is preferably in intimate contact with the seal element 160 to effectively seal the interior of the RV 10. The seal element 160 can be formed of any number of conventional sealing materials, such as a suitable insulation, etc. In addition, another seal element (not shown) can be provided on an underside of the skirt. Also, when the slide-out section 100 is in the extended position, the seal element 160 effectively seals against the walls of the slide-out section 100 to prevent unwanted elements from entering the main cabin 20.

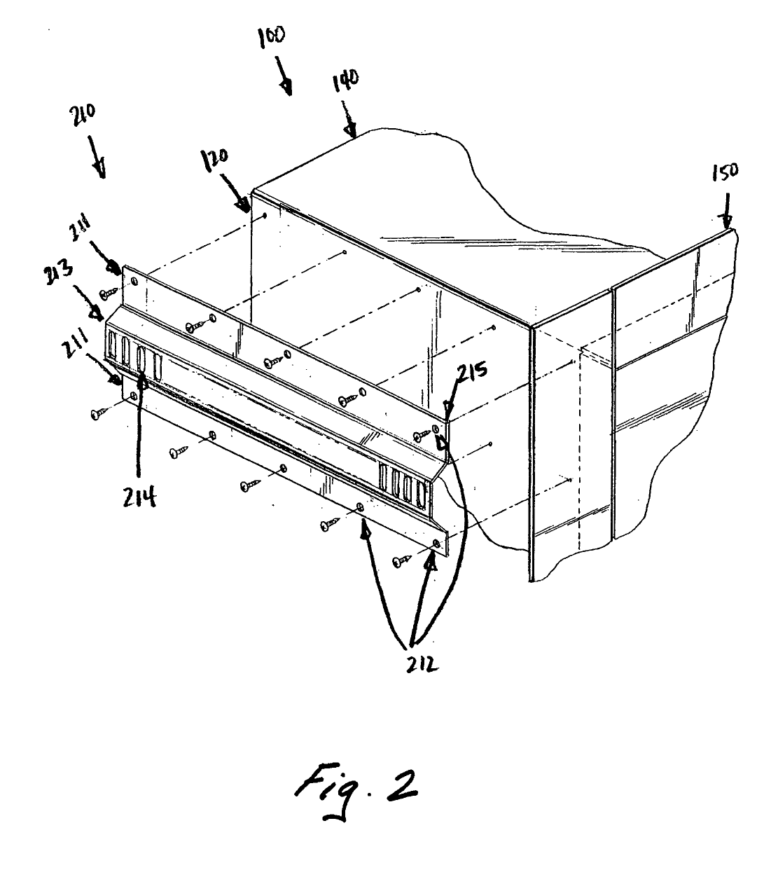

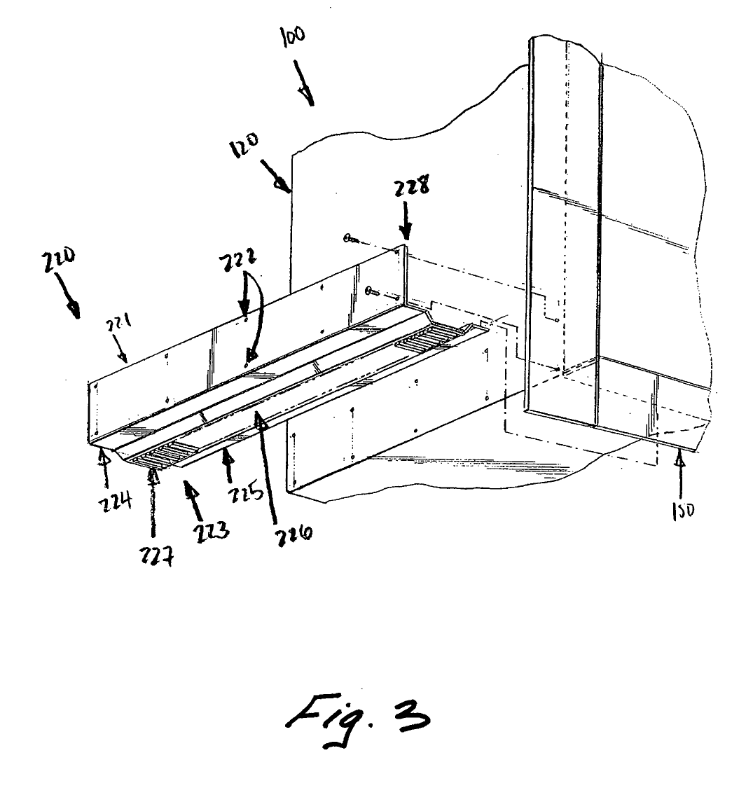

FIG. 2 is a sectional view taken along line 2 of FIG. 1 of an upper track 210 (a guide member) mounted to one surface of the slide-out section 100, and FIG. 3 is a sectional view taken along line 3 of FIG. 1 of a lower track 220 mounted to the slide-out section 100. The upper track 210 is mounted along each of the top portions of the side walls 120 of the slide-out section 100; however, it will be appreciated that the upper track 210 is not limited to being mounted near the top portion of the side wall 120 but rather can be placed in a location more toward the middle of the side wall 120. In addition to the lower track 220 being mounted to an underside of a floor of the slide-out section 100, the lower track 220 is also mounted along each of the lower portions of the side walls 120 of the slide-out section 100 where the side walls intersect the floor. The upper track 210 and the lower track 220 are provided in the slide-out mechanism 200 to be able to drive the slide-out section 100 between the retracted and the extended positions based on their cooperation with a drive mechanism as will be described below.

The closet 30 includes a ceiling (not shown) and side walls 32 (FIGS. 4-6). When the slide-out section 100 moves between the extended position and the retracted position, the side walls of the slide-out section 100 move parallel to the side walls 32 of the closet 30.

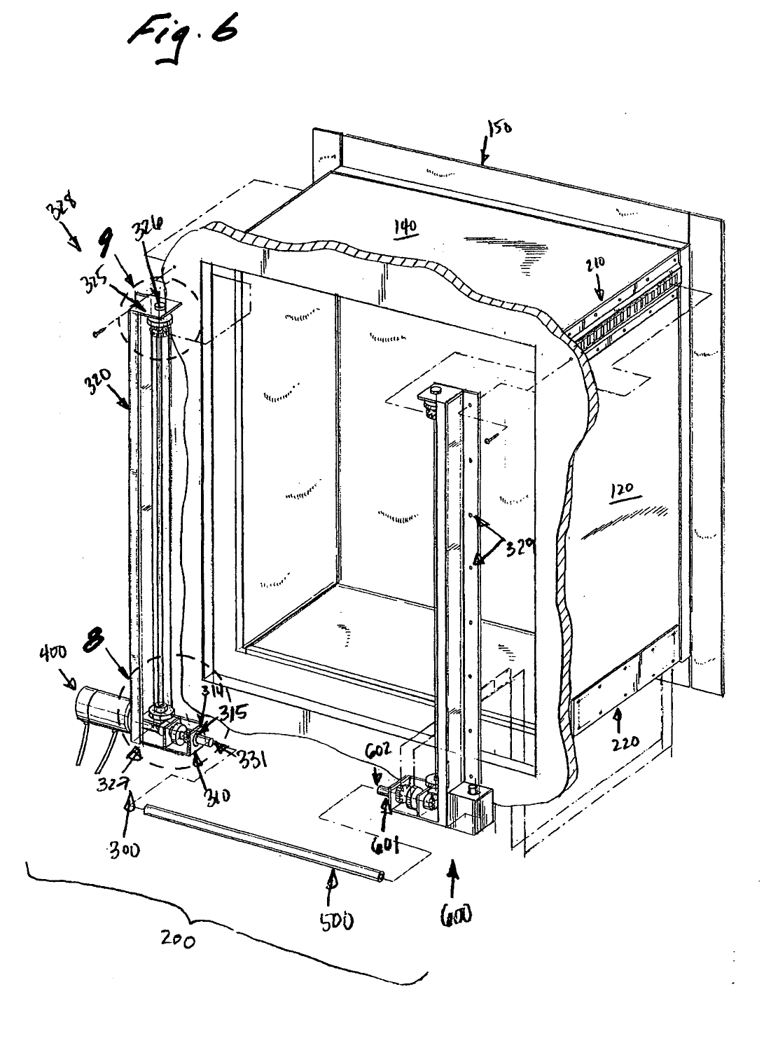

The upper track 210 is an elongated member that includes side portions (side flanges or side planar land portions) 211 that extend longitudinally along the sides of the upper track 210. Since the side portions 211 act as mounting surfaces that seat against the surface to which the upper track 210 is to be mounted, the side portions 211 lie in the same plane. Mounting holes 212 are provided on the side portions 211 of the upper track 210 for fastening the upper track 210 to the side walls 120 of the slide-out section 100. Between the side portions 211, a middle portion 213 is provided which is slightly raised from the side portions 211 of the upper track 210 such that the middle portion 213 lies outside of the plane containing the side portions 211 and in fact, the middle portion 213 includes a planar portion that is connected to the planar side portions 211 by a pair of ramped sections. A plurality of slots 214 are formed in the raised middle portion 213 and are arranged linearly along the planar portion of the middle portion 213. The slots 214 define a degree of travel of the slide-out section 100 as will be seen hereinafter and therefore, it will be appreciated that the spacing between the slots 214 is preferably uniform and the slots 214 can extend from one end to the other end of the upper track 210 or they can be formed from one end and then terminate at a location other than at the other end. As will be discussed in greater detail, the slots 214 act as drive features by cooperating with a drive mechanism to permit movement of the slide-out section 100 and more particularly, the slots 214 engage with a top sprocket 341 mounted in a upper gear assembly 340 (FIGS. 6, 7, and 9) of the slide-out mechanism 200, as described below. Alternatively, the raised middle portion 213 can be provided with ribs, in place of the slots 214, for engaging with the top sprocket 341 and in this embodiment, teeth of the top sprocket 341 engage successive ribs to effectuate a driving action of the slide-out section 100.

The upper track 210 can thus be thought of as an elongated bracket that can be formed of any number of suitable materials, including but not limited to metals and hard, durable plastics with metals being preferred since it needs to be a robust part that can withstand the continuous driving action of the drive mechanism 200.

The lower track 220 is formed roughly in an L shape and also can be thought of as a bracket member. The L-shaped lower track 220 includes a vertical wall or surface 221 with mounting holes 222 being formed therein for fastening the lower track 220 to the bottom portions of the side walls 120 of the slide-out section 100. The lower track 220 also includes a horizontal surface or wall 223 that extends away from a lower edge of the vertical wall 221 and is disposed against and underside of the floor of the slide-out section 100. The horizontal surface 223 is similar to the upper track 210 in that it includes an inner side portion (inner flange) 224, an outer side portion (outer flange) 225, and a middle portion 226 disposed between the side portions 224, 225. The middle portion 226 is formed as a recessed platform that extends between the side portions 224, 225 of the horizontal surface 223 of the lower track 220. Thus, when the horizontal surface 223 is disposed against the underside of the floor of the slide-out section 100, the middle portion 226 is spaced slightly thereaway, while the side portions 224, 225 seat against the underside to permit mounting of the lower track 220. A plurality of ribs 227 is disposed on the underside of the lowered middle portion 226 of the horizontal surface 223 of the lower track 220. As with the slots 214 of the upper track 210, the ribs 227 are arranged linearly along the middle portion 226 and the distance that the ribs 227 travel along the middle portion 226 can be varied so as to define and limit the degree of travel of the slide-out section 100.

As will be described in greater detail hereinafter and similar to the slots 214, the ribs 217 cooperate with the drive mechanism 210 and more particularly, the ribs 227 engage a bottom sprocket 332 mounted in a bottom gear assembly 330 of the slide-out mechanism 200, as described below. Alternatively, the middle portion 226 of the horizontal surface 223 of the lower track 220 can be provided with slots, in place of the ribs 227, for engaging with the bottom sprocket 332. In this embodiment, the lower track 220 acts similar to the upper track 210 in that the respective rotating sprocket serves to successively engage the slots to cause the respective track to be driven, thereby causing the slide-out section 100 to be advanced.

The outer side portion 225 of the horizontal surface 223 is the side portion positioned farthest from the vertical surface 221. Mounting holes (not shown) can be provided on the outer side surface 225 for fastening the lower tracks 220 to the underside of the floor 130 of the slide-out section 100.

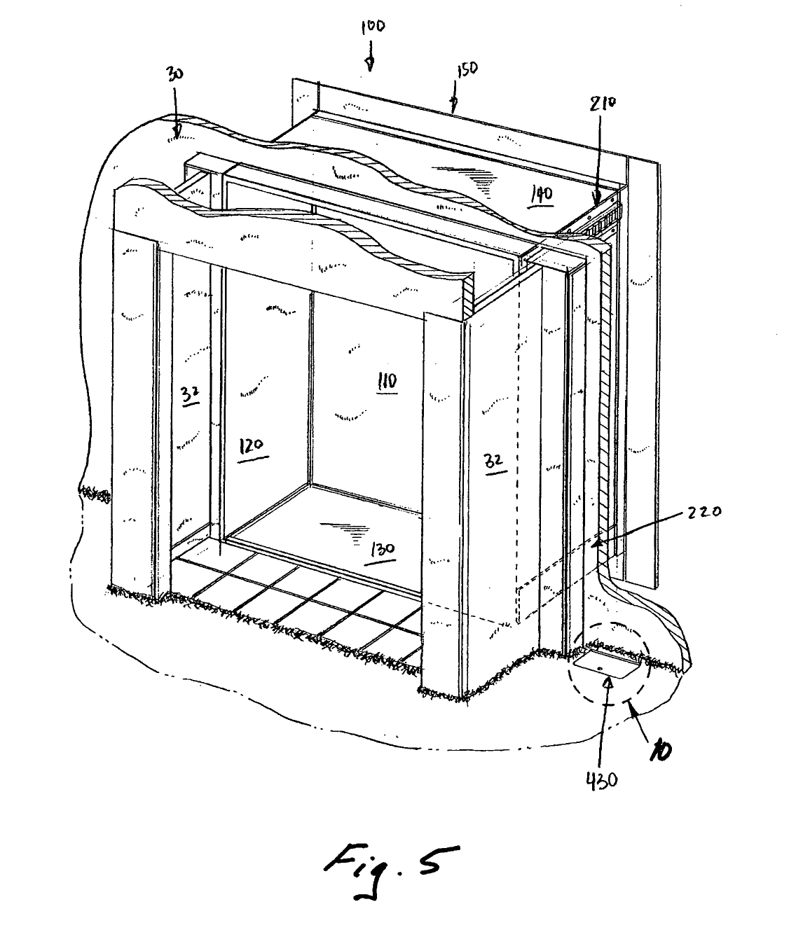

FIG. 4 is a perspective view of an interior of the RV 10 of FIG. 1 with the slide-out section 100 in the retracted position; and FIG. 5 is a perspective view of an interior of the RV 10 of FIG. 1 with the slide-out section 100 in the extended position. These figures also show the relationship between the slide-out section 100 and the closet 30. The sliding motion of the slide-out section 100 from the retracted position to the extended position is limited by the lengths of the upper track 210 and the lower track 220. The upper track 210 can be formed to have the same length as the lower track 220. The upper track 210 and the lower track 220 are aligned such that their lengths in the longitudinal direction is parallel to the direction of expansion or retraction of the slide-out section 100. In addition, the distance that the ribs 227 and the slots 214 are formed on their respective members is preferably the same since the two sprockets preferably engage one end of the ribs 227 or slots 214 and as they successively engage these drive features, the last of the ribs 227 should be encountered by the respective sprocket at the same time that the other sprocket engages the last of the slots 214. This ensures that the bottom (floor) of the slide-out section 100 is advanced at the same speed and to the same degree as the top (ceiling) thereof.

As can be seen in FIG. 4, the closet 30 acts to contain the slide-out section 100 so to offer an attractive setting or environment to the user of RV 10. More specifically, the closet 30 merely looks like a typical closet from the inside of the RV 10 until the user opens an optional closet door whereupon the user will see that the slide-out section 100 is incorporated into the closet 30 so as to permit the dimensions of the closet 30 to be easily increased by actuation of the slide-out mechanism 200.

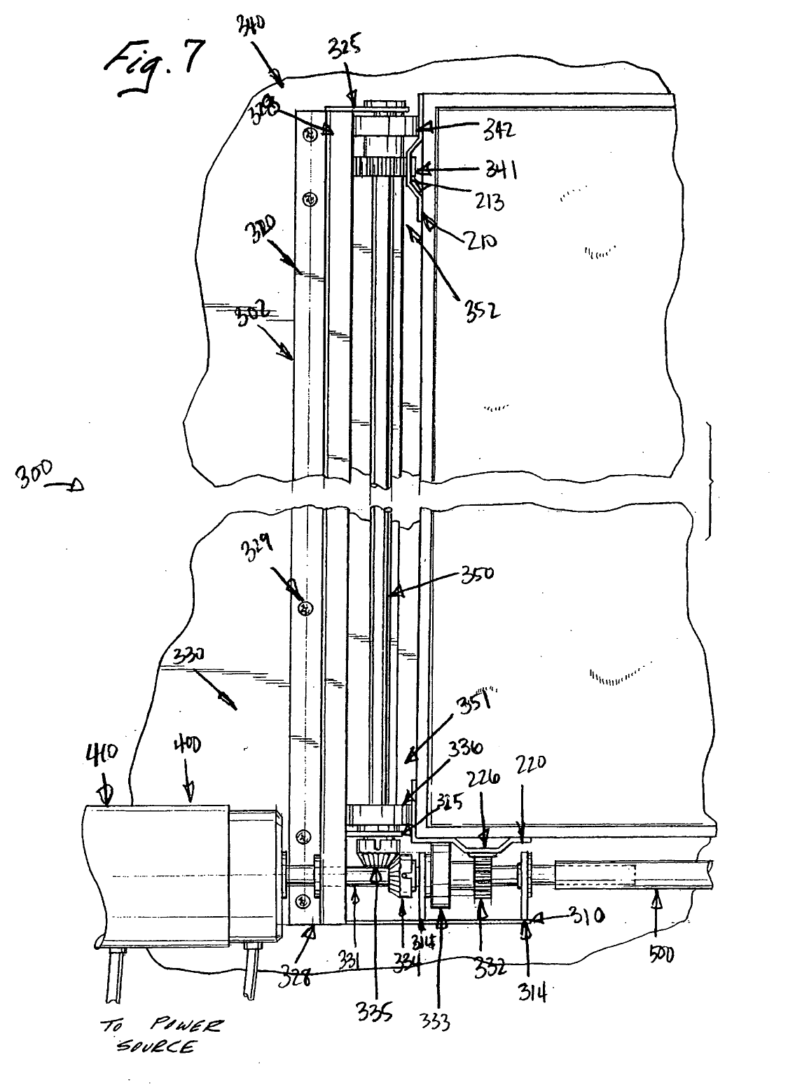

FIG. 6 is an exploded perspective view of the slide-out mechanism 200 and the interior of the RV 10 of FIG. 1 with the slide-out section 100 in the extended position; and FIG. 7 is an enlarged perspective view of the slide-out mechanism 200 mounted to the slide-out section 100 of FIG. 1.

The slide-out mechanism 200 functions as a mechanical drive mechanism for causing the controlled extension and retraction of the slide-out section 100. The slide-out mechanism 200 moves the slide-out section 100 of the RV 10 between the retracted position and the extended position shown in FIG. 1. It will be appreciated and is described in greater detail hereinafter that the slide-out mechanism 200 can either be of a manual type or can be an automated or motorized drive system.

The exemplary slide-out mechanism 200 includes an active side assembly 300 and a passive side assembly 600. The active and passive side assemblies 300, 600 are enclosed between the side walls 120 and the floor 130 of the slide-out section 100 and the side walls 32 and the floor of the closet 30, respectively.

The difference between the active side assembly 300 and the passive side assembly 600 is that the active side assembly 300 is connected directly to a drive mechanism 400, such as a crank or a motor. The drive mechanism 400 drives the active side assembly 300, and the active side assembly 300 is operatively connected to the passive side assembly 600 by a drive shaft, such as a telescoping shaft or axle 500. The passive side assembly 600 is not directly connected to the drive mechanism 400 but rather is operatively coupled thereto through the active side assembly 300 and is therefore driven by the active side assembly 300.

The length of the telescoping shaft 500 can be adjusted so that the slide-out mechanism 200 can be mounted to closets or other slide-out rooms of different widths. In other words, the manufacturer of the present system needs only to make and supply a transverse drive shaft (telescoping shaft 500) of one length and the end user can adjust the telescoping shaft 500 according to the particular specifications of the user's slide-out section 100. The active and passive side assemblies 300, 600 are mounted to the side walls 120 of the slide-out section 100, and the telescoping shaft 500 is extended or retracted to be able to connect to both the active and the passive side assemblies 300, 600.

The slide-out mechanism 200 is disposed in a space between the closet 30 and the slide-out section 100 and is coupled to the closet 30 in the main cabin 20 of the RV 10. The slide-out mechanism 200 is positioned close to the interior side of the exterior wall 21 of the main cabin 20, as shown in FIGS. 4 and 5. A slot (not shown) is cut into the floor of the main cabin 20 to allow the slide-out mechanism 200 to engage with the lower track 220 mounted to the slide-out section 100. The components of the slide-out mechanism 200 that are disposed below the slide-out section 100, such as the telescoping shaft 500 connecting the active side assembly 300 and the passive side assembly 600, are recessed within a slot formed in the floor of the main cabin 20. In other words, the floor of the main cabin 20 has a cut-away formed therein to receive and accommodate some of the operating, working components of the present system. Thus, the floor of the slide-out section 100 is able to slide against the floor of the main cabin 20 and there is a slight space therebetween in which the horizontal surface 223 is disposed and is permitted to axially travel as the slide-out section 100 travels.

The slide-out mechanism 200 of the present invention is not limited to being placed in the closet 30 and can be used in combination with slide-out sections in other areas of the RV 10. The closet 30 is constructed in a conventional manner in that it includes the ceiling and the side walls 32. However, the closet 30 does not include a rear wall, which would be part of the exterior wall 21 of the main cabin 20. Instead, the rear wall is removed from the closet 30 so that the slide-out section 100 may be extended and retracted with respect to the main cabin 20. The floor of the closet 30 is the same floor of the main cabin 20; however, a separate floor may be provided in the closet 30. FIGS. 4 and 5 show a common floor between the main cabin 20 and the closet 30, and a carpet covers the floor in the main cabin 20, while the floor of the closet 30 is preferably tiled or does not contain a rug since the floor of the slide-out section slides across the floor of the closet 30.

The active side assembly 300 includes a frame 302 formed in an L-shape with a horizontal bottom frame member 310 and a vertical side frame member 320. The horizontal bottom frame member 310 is formed with an L-shaped bracket 311 with one arm 312 positioned flush against an underside of the floor of the closet 30 and the other arm 313 extending from arm 312 against the exterior wall 21 of the main cabin 20 or against a support surface that is formed as part of the main cabin 20.

The vertical side frame member 320 is formed with a U-shaped channel 321, or a similarly shaped frame member, e.g., a C-shaped channel, with an opening 322 facing the slide-out section 100. The U-shaped channel 321 has two parallel side surfaces or faces 323 and a middle surface or face 324 between the side surfaces 323 and disposed perpendicular to the side surfaces 323.

Mounting holes 329 are provided on the side surface 323 of the U-shaped channel 321 that is closest to the exterior wall 21 of the main cabin 20 for mounting the U-shaped channel 321 to the exterior wall 21. Alternatively, as shown in FIGS. 6, 7, and 9, the side surface 323 of the U-shaped channel 321 on which the mounting holes 329 are provided can be extended away from the opening 322 of the U-shaped channel 321 so that the mounting holes 329 are not positioned within the opening 322.

The vertical side frame member 320 also includes a bottom (lower) end 327 and a top (upper) end 328. The bottom gear assembly 330 of the active side assembly 300 is disposed on the horizontal bottom frame member 310 near the bottom end 327 of the vertical side frame member 320, and the upper gear assembly 340 of the active side assembly 300 is disposed at the top end 327 of the vertical side frame member 320.

Two vertical mounting plates 314 are provided in the horizontal bottom frame member 310, and two horizontal mounting plates 325 are provided in the vertical side frame member 320 for mounting the bottom gear assembly 330 and the upper gear assembly 340, respectively, as described in more detail below.

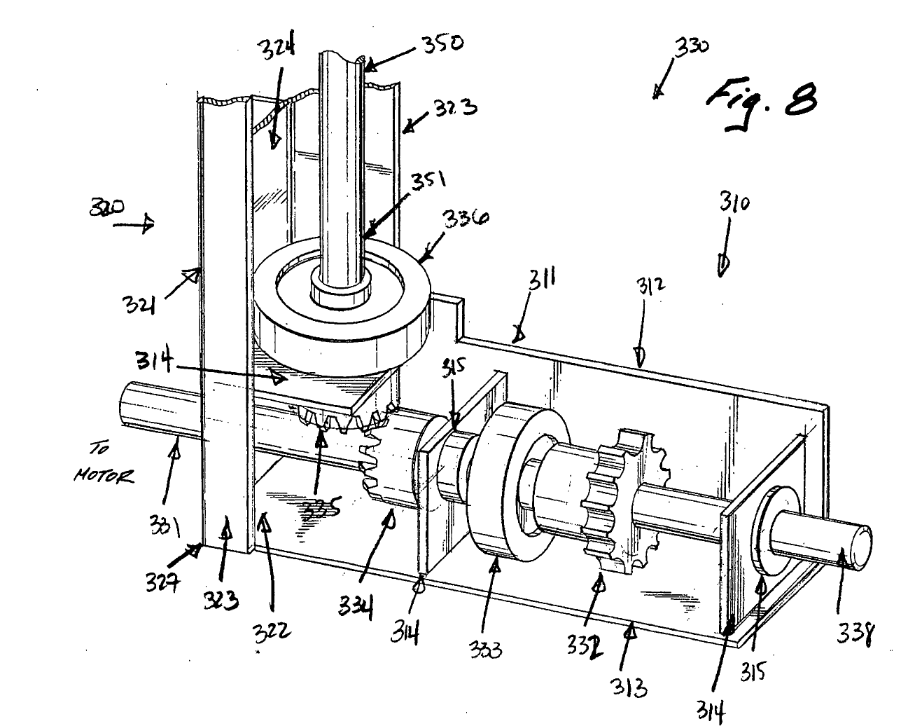

FIG. 8 is a sectional view taken along the line 8 of FIG. 6 of the bottom gear assembly 330 of the slide-out mechanism 200. The bottom gear assembly 330 includes a drive shaft 331 connected to the drive mechanism 400 and the bottom sprocket 332, a first roller support 333, and a first bevel gear 334 mounted onto the drive shaft 331.

The two vertical mounting plates 314 are disposed parallel to each other inside the L-shaped bracket 311 of the horizontal bottom frame member 310. The vertical mounting plates 314 rotatably support the drive shaft 331, and the mounting plates 314 extend vertically from one arm 312 to the other arm 313 of the L-shaped bracket 311. Holes 315 are provided in each of the mounting plates 314 and in the middle surface 324 of the U-shaped channel 321 facing the slide-out section 100. The drive shaft 331 is held by bearings disposed in the holes 315 in the mounting plates 314 and in the middle surface 324 of the U-shaped channel 321.

Rotational power is supplied by the drive mechanism 400 which rotates the drive shaft 331 on which the bottom sprocket 332, the first roller support 333, and the first bevel gear 334 are non-rotatably mounted and therefore, these members rotate in unison with the drive shaft 331. The bottom sprocket 332 and the first roller support 333 are mounted between the two mounting plates 314. The first roller support 333 supports the inner side portion 224 of the horizontal surface 223 of the lower track 220 as the lower track 220 is extended or retracted by the bottom sprocket 332. In other words, the first roller support 333 contacts and seats against the planar side flange of the horizontal surface 223.

The bottom sprocket 332 drivingly engages the ribs 227 on the lower track 220 to extend or retract the lower track 220. The slide-out section 100 is extended or retracted depending on the direction of rotation of the bottom sprocket 332. At the same time, the first roller support 333 rotates while supporting the underside of the inner side portion 224 of the lower track 220. The bottom sprocket 332 and the first roller support 333 are dimensioned so that the lower track 220 is extended and retracted in a stable manner parallel to the floor of the main cabin 20.

The first bevel gear 334 is mounted on the drive shaft 331 between the U-shaped channel 321 and the mounting plate 314 in the horizontal bottom frame member 310 that is positioned closest to the U-shaped channel 321. The first bevel gear 334 is oriented so that the teeth are positioned toward the U-shaped channel 321.

A second bevel gear 335 is disposed perpendicularly to the first bevel gear 334, and the teeth of the first bevel gear 334 engage with the teeth of the second bevel gear 335. The second bevel gear is non-rotatably mounted on a connecting shaft 350 with a bottom end that connects the bottom gear assembly 330 and a top end 352 that connects to the upper gear assembly 340. The first bevel gear 334 rotates with the drive shaft 331 and transfers the rotational motion to the second bevel gear 335.

Two horizontal mounting plates 325 are provided on the vertical side frame member 320 for rotatably supporting the connecting shaft 350. One of the horizontal mounting plates 325 is disposed at the top end 352 of the connecting shaft 350, and the other horizontal mounting plate 325 is disposed above the second bevel gear 335 at the bottom end 351 of the connecting shaft 350. The horizontal mounting plates 325 are disposed parallel to each other inside the U-shaped channel 321 of the vertical side frame member 320, and the mounting plates 325 extend horizontally between the side surfaces 323 and the middle surface 324 of the U-shaped channel 321. Holes 326 are provided in each of the mounting plates 325, and the connecting shaft 350 is held by bearings disposed in the holes 326.

The mounting plate 325 disposed closer to the bottom end 351 of the connecting shaft 350 is disposed between the second bevel gear 335 and a second roller support 336. The second roller support 336 is non-rotatably mounted on the connecting shaft 350 so that the second roller support 336 supports the vertical surface 221 of the lower track 220 as the lower track 220 is extended or retracted by the bottom sprocket 332 in the bottom gear assembly 330. The second roller support 336 contacts the portion of the vertical surface 221 of the lower track 220 positioned below the mounting holes 222.

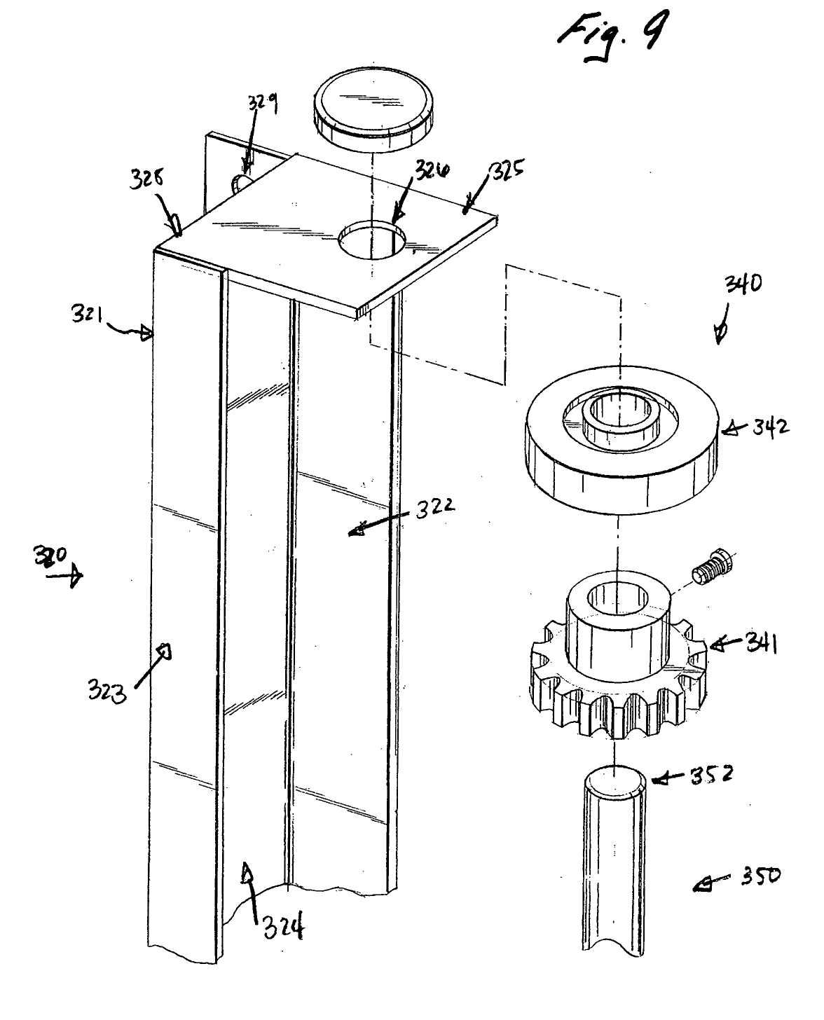

FIG. 9 is a sectional view taken along the line 9 of FIG. 6 of the upper gear assembly 340 of the slide-out mechanism 200. The upper gear assembly 340 includes the top sprocket 341 and a third roller support 342. The top sprocket 341 and the third roller support 342 are non-rotatably mounted below the mounting plate 325 at the top end of the connecting shaft 350.

Rotational power supplied by the drive mechanism 400 via the connecting shaft 350 rotates the top sprocket 341 and the third roller support 342. The third roller support 342 supports the side portion 211 disposed at the top of the upper track 210 as the upper track 210 is extended or retracted by the top sprocket 341.

The top sprocket 341 drivingly engages with the slots 214 on the upper track 210 to extend or retract the upper track 210, depending on the direction of rotation of the top sprocket 341. At the same time, the third roller support 342 rotates while supporting the side portion 211 at the top of the upper track 210. The top sprocket 341 and the third roller support 342 are dimensioned so that the upper track 210 extends and retracts in a stable manner parallel to the side wall 32 of the closet 30.

A hole (not shown) is provided on the free end 338 of the drive shaft 331 opposite the drive mechanism 400. The telescoping shaft 500 is fastened to the drive shaft 331 using a fastener such as a bolt and hex nut in the hole. The telescoping shaft 500 can be extended to connect the free end 338 of the drive shaft 331 of the active side assembly 300 to a free end 602 of a passive shaft 601 of the passive side assembly 600. The passive shaft 601 is identical to the drive shaft 331 in the active side assembly 300 except that the passive shaft 601 is not connected directly to the drive mechanism 400, e.g., a crank or a motor. The components of the passive side assembly 600 which are identical to the parts of the active side assembly 300 are denoted by identical reference characters and will not be described in detail.

An end 215 of the upper track 210 and an end 228 of the lower track 220 that are closest to the outside of the RV 10 are connected to the skirt 150. Alternatively, as shown in FIGS. 5 and 6, the skirt 150 is provided separately from the upper track 210 and the lower track 220, but the respective ends 215, 228 are disposed close the skirt 150. The skirt 150 includes four t-molding legs which are connected together to provide a seal against the elements in both the retracted and extended positions.

The drive mechanism 400 can be a motor that allows the user to extend and retract the slide-out mechanism 200 by pushing a button or by flipping a switch, for example. Alternatively, the drive mechanism 400 can be a hand crank for manually rotating the drive shaft.

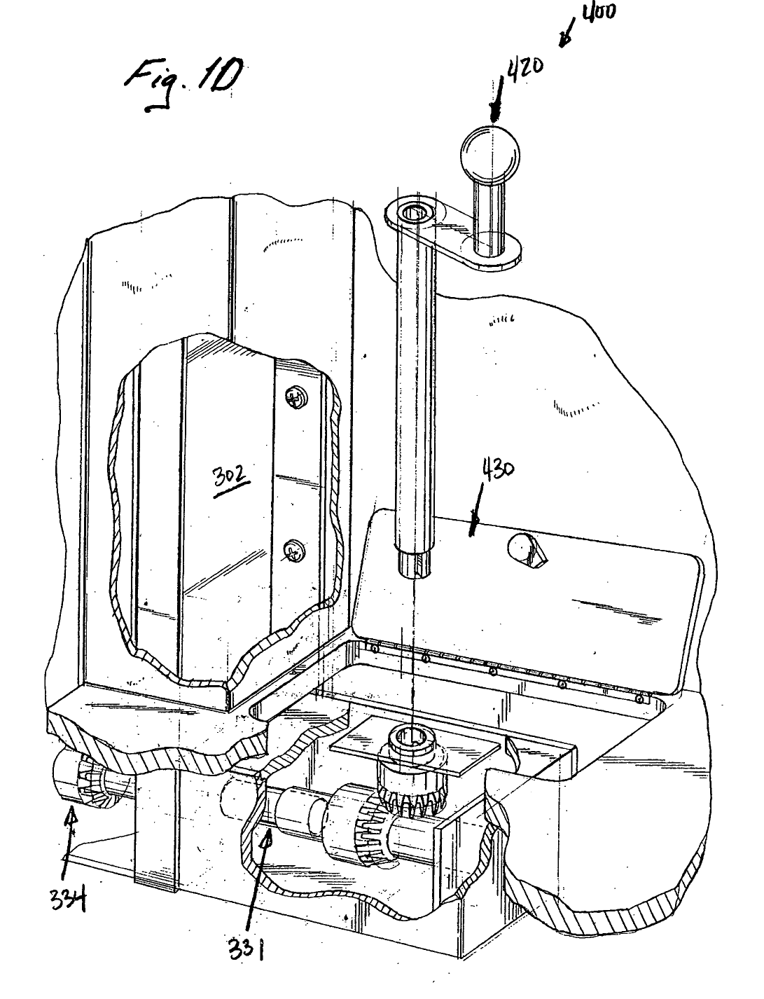

As provided in the embodiment of the present invention shown in FIGS. 1-10, the drive mechanism can also be a motor 410 that is provided with a manual override for connecting a hand crank 420 when a power source is unavailable. FIG. 10 is a sectional view taken along the line 10 of FIG. 5 of the bottom gear assembly 230 of a slide-out mechanism 200 and the hand crank 420. The hand crank 420 is connected to the end of the passive shaft 601 in the passive side assembly 600, which is identical to where the motor 410 is disposed in the active side assembly 300. When the hand crank 420 is used as the drive mechanism 400, the motor 410 is not actuated, and the transfer of power described above in connection with the active side assembly 300, which is connected to the motor 410, occurs instead in the passive side assembly 600. Only one side assembly is powered whether the motor 410 acts as the drive mechanism 400 for the active side assembly 300 or the hand crank 420 acts as the drive mechanism 400 for the passive side assembly 600.

The hand crank 420 can be used to power the slide-out mechanism 200 and is disposed in a cabinet or storage compartment 430 adjacent to the slide-out section 100, as shown in FIGS. 4, 5, and 10, for easy access when the user wants to activate the slide-out mechanism 200 without using the motor 410.

The operation of the slide-out mechanism 200 will now be described with the slide-out section 100 starting in a retracted position.

When the user wants to extend the slide-out section 100, the user activates the slide-out mechanism 200 by operating the drive mechanism 400 attached to the active side assembly 300.

After the user activates the drive mechanism 400, e.g., by activating the motor 410 or turning the hand crank 420, the drive shaft 331 connected to the drive mechanism 400 rotates, thereby rotating the bottom sprocket 332, the first roller support 333, and the first bevel gear 334 disposed along the drive shaft 331. The bottom sprocket 332 drivingly engages the ribs 227 in the lower track 220 to drive the slide-out section 100 from the corresponding lower of the slide-out section 100. The first roller support 333 guides and supports the inner side surface 224 of the lower track 220 as it is extended with the slide-out section 100. The second roller support 336 on the connecting shaft 350 also guides and supports the vertical surface 221 of the lower track 220.

As the drive shaft 331 is rotated by the drive mechanism 400, the first bevel gear 334 is engaged with the second bevel gear 335 on the bottom end 351 of the connecting shaft 350 to transfer rotational power from the drive shaft 331 to the connecting shaft 350. The top sprocket 341 and the third roller support 342 at the top end 352 of the connecting shaft 350 rotate with the connecting shaft 350. The top sprocket 341 drivingly engages the slots 214 in the upper track 210 to extend the slide-out section 100, since the upper track 210 is mounted to the top of the side wall 120 of the slide-out section 100. The third roller support 342 guides and supports the upper portion 211 of the upper track 210 as it extends with the slide-out section 100.

The telescoping shaft 500 is connected to the free end 338 of the drive shaft 331 opposite the drive mechanism 400. The telescoping shaft 500 transfers the rotational motion from the drive mechanism 400 via the drive shaft 331 to the passive side assembly 600. The telescoping shaft 500 is fastened to the free end 602 of the passive shaft 601 closest to the active side assembly 300.

The rotation of the passive shaft 601 rotates the bottom sprocket 332, the first roller support 333, and the first bevel gear 334 in the passive side assembly 600. As described above in connection with the active side assembly 300, the bottom sprocket 332 drivingly engages the ribs 227 in the lower track 220 to extend the slide-out section 100, and the first roller support 333 guides and supports the inner side surface 224 of the lower track 220 as the lower track 220 is extended with the slide-out section 100. The second roller support 336 on the connecting shaft 350 also guides and supports the vertical surface 221 of the lower track 220.

As the passive shaft 601 is rotated, the first bevel gear 334 is engaged with the second bevel gear 335 on the bottom end 351 of the connecting shaft 350 to transfer rotational power from the passive shaft 601 to the connecting shaft 350 on the passive side assembly 600. The top sprocket 341 at the top end 352 of the connecting shaft 350 drivingly engages the slots 214 in the upper track 210 to extend the slide-out section 100, and the third roller support 342 guides and supports the upper portion 211 of the upper track 210 as the upper track 210 extends with the slide-out section 100.

After the slide-out section 100 has been extended to its preferred configuration, the user can activate the drive mechanism 400 to retract the slide-out section 100 back to its original retracted configuration. The operation of the slide-out mechanism 200 is the same as for the extending operation described above except that the drive shaft 331 is rotated in the opposite direction. The top and bottom sprockets 341, 332 then rotate in the opposite direction, thereby causing the upper tracks 210 and the lower tracks 220 to retract the slide-out section 100.

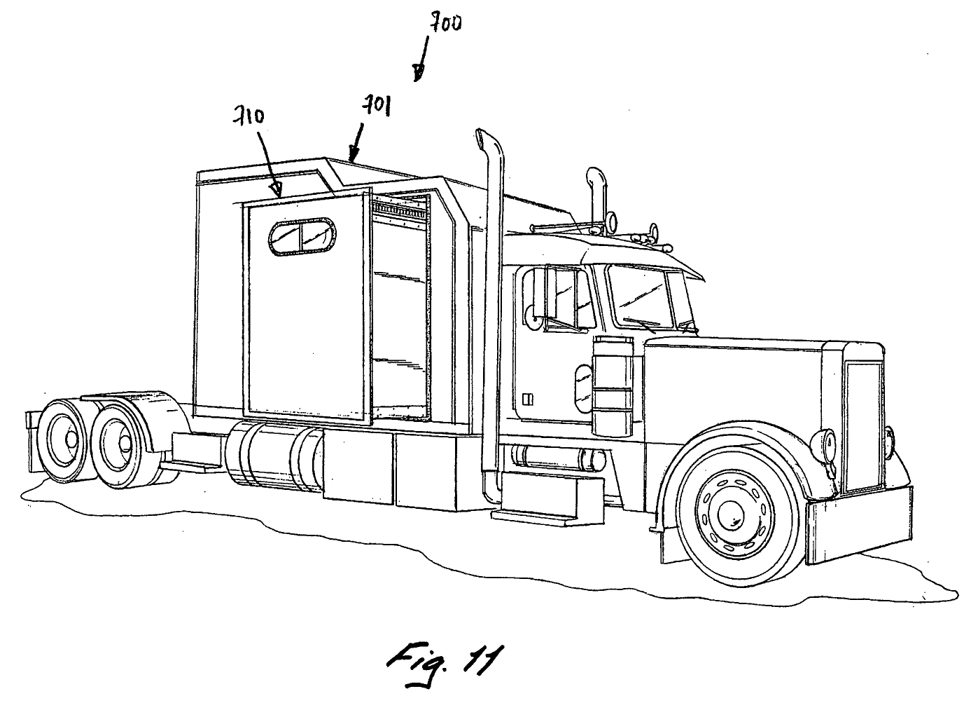

As described above, the slide-out mechanism 200 of the present invention can be provided in different types of RVs. Additionally, the slide-out mechanism 200 can also be provided in other types of vehicles. FIG. 11 is a perspective view of a sleeper box 701 on a truck tractor 700 with a slide-out section 710 in an extended position, according to another embodiment of the present invention. In this embodiment, the available interior space of the sleeper 701 can easily be extended by activating an associated drive mechanism to cause the slide-out section to move to the extended position.

Since the drive shaft 331, the telescoping shaft 500, and the two connecting shafts 350 in the active side assembly 300 and the passive side assembly 600 are driven collectively by the single drive mechanism 400, there is no risk of binding or misalignment of the slide-out mechanism 400. The two upper tracks 210 and the two lower tracks 220 are synchronized. Thus, there is no danger of a corner of the slide-out section 100 moving at a faster rate than another corner. Furthermore, there is no danger that two different corners of the slide-out section 100 would start to move at different times.

Since the slide-out mechanism 200 is driven by a upper gear assembly 340 and a lower gear assembly 330, the top and the bottom of the slide-out section 100 are extended or retracted together. This is an advantage over the prior art in which only the bottom of the slide-out section 100 is extended or retracted. By driving both the top and the bottom of the slide-out section 100 together, the risk of binding or misalignment of the slide-out mechanism 400 is reduced. The top and the bottom of the slide-out section 100 can be synchronized and driven at the same speed.

The top and bottom sprockets 341, 332 engage with the upper tracks 210 and the lower tracks 220 in a non-slip manner, thereby preventing misalignment of the slide-out section 100.

Since the telescoping shaft 500 is provided for connecting the passive side assembly 600 to the active side assembly 300, the slide-out mechanism 200 can be adapted for use with slide-out sections 100 of varying widths. Simply by extending or retracting the length of the telescoping shaft 500, the slide-out mechanism 200 can be mounted to wider or narrower slide-out sections.

A motor and/or a hand crank can be provided for powering the slide-out mechanism 200. The motor allows the user to extend and retract the slide-out mechanism by pushing a button or by flipping a switch, for example. The motor can be provided with a manual override for connecting a hand crank like the hand crank described above.

The drive mechanism 400, e.g., the hand crank or motor, can be placed in a cabinet or storage compartment 430 adjacent to the slide-out section 100 for easy access when the user wants to activate the slide-out mechanism 200.

The slide-out mechanism is easy to assemble and to install. It can be bought separately to install into an RV. Furthermore, it is compact and fits into a small space between the slide-out section and the closet or other room in the RV.

It will also be understood that while the hand crank assembly was discussed more in terms of backing up the main motorized dive system, the hand crank assembly can be used along in a system that does not include a motor, In such a setting or application, the user simply rotates or otherwise causes the movement of the hand crank assembly so as to move the slide-out section 100 between extended and retracted positions. In this embodiment, the hand crank can be in the form of the one shown in FIG. 10 or it can be of another type. For example, a tool, like a ratchet wrench can engage a complementary mating feature formed at the end of the drive shaft so as to permit the user to simply mate the two together and then rotate the drive shaft by manipulating the tool. This embodiment saves some room since it is not necessary to house a motor, etc., as part of the drive mechanism.

Having described embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

1. A slide-out mechanism for controllably moving a slide-out section that is associated with a vehicle comprising:
a pair of first guide members that are operatively coupled to the slide-out section, each of the first guide members having a plurality of first drive features formed as a part thereof; and
a pair of second guide members that are disposed on an outer surface of a pair of opposite side walls of the slide-out section, each second guide member having a plurality of second drive features formed is a part thereof; and
a drive mechanism having a pair of first drive members that complement and engage the first drive features and a pair of second drive members that complement and engage the second drive features for controllably moving the slide-out section between a retracted position and an extended position as the first drive members engage successive first drive features under action of the drive mechanism, wherein the second drive members are operatively coupled to the first drive members so that movement of the first drive members is translated into movement of the second drive members resulting in the first guide members and the second guide members being driven together resulting in the slide-out section being driven between the retracted position and the extended position.

2. The slide-out mechanism of claim 1, wherein the first drive features comprise a plurality of slots arranged linearly along a surface of the first guide member.

3. The slide-out mechanism of claim 1, wherein the first drive features comprise a plurality of ribs arranged linearly along a surface of the first guide member.

4. The slide-out mechanism of claim 1, wherein the pair of first guide members are arranged on an underside of a floor of the slide-out section.

5. The slide-out mechanism of claim 1, wherein each of the guide members comprises an elongated bracket having one face that includes a recessed floor section formed between a pair of planar land sections that lie flush against a surface of the slide-out section, the first drive features being formed in the recessed floor section.

6. The slide-out section of claim 1, wherein one of the first guide members is disposed on an underside of a floor of the slide-out section at an intersection between one side wall and the floor while the other first guide member is disposed on an underside of the floor at an intersection between the other side wall and the floor.

7. The slide-out section of claim 6, wherein the first guide member is in the form of an L-shaped bracket with a horizontal section being disposed against the underside of the floor and a vertical section is disposed against one side wall of the slide-out section.

8. The slide-out mechanism of claim 1, wherein each of the second guide members comprises a guide track that is securely coupled to one side wall of the slide-out section and the second drive features comprise a plurality of slots formed linearly along one face thereof, wherein the drive mechanism further includes a pair of rotatable gears that engage the slots and are operatively coupled to the first drive member such that the first drive members and the gears rotate together.

9. The slide-out section of claim 1, wherein the slide-out section is a closet extension that is disposed within an enclosed section of a closet provided in a main cabin of the vehicle such that the first guide members are disposed within a recessed section of a floor of the closet of the main cabin underneath a floor of the slide-out section.

10. The slide-out section of claim 9, wherein the closet includes a pair of opposing side walls that extend up from the floor and the slide-out section further includes a pair of opposing side walls that face the side walls of the closet and extend between the floor and a ceiling of the side-out section and a rear wall that extends between the side walls and the floor and ceiling, the rear wall acting as an exterior wall of the main cabin.

11. The slide-out mechanism of claim 1, wherein each of the first drive members comprises a rotatable gear that is disposed in a fixed relation to the slide-out section, the rotatable gear meshing with the first drive features such that rotation of the gear causes advancement of the guide member, thereby causing the slide-out section to be driven to one of the extended position and the retracted position.

12. The slide-out mechanism of claim 1, wherein the drive mechanism includes an actuatable motor that can be driven in a first direction and a second direction, wherein driving the motor in the first direction causes rotation of the first drive members in a first direction resulting in the slide-out section being driven to the extended position and driving the motor in the second direction causes rotation of the first drive members in a second direction resulting in the slide-out section being driven to the retracted position.

13. The slide-out mechanism of claim 1, wherein the first drive members are in the form of toothed gears that are connected to one another by a drive shaft which extends transversely across the slide-out section, wherein rotation of the toothed gears is translated into axial movement of the slide-out section.

14. The slide-out section of claim 1, wherein the drive mechanism includes a pair of opposing vertical frame assemblies that are disposed proximate to an opening formed in an exterior wall of the recreational vehicle through which the slide-out section extends and retracts, one of the first drive members being associated with one vertical frame assembly, while the other first drive member is associated with the other vertical frame assembly.

15. The slide-out section of claim 14, wherein each vertical frame assembly includes an elongated support member that has a first end and an opposing second end that is proximate one of the first drive members and a vertical shaft that extends substantially from the first end to the second end of the support member, the first end of the vertical shaft supporting the second drive member that cooperatively engages the second drive features associated with one of the second guide members, the second end of the vertical shaft having a first drive gear that is operatively coupled to a second drive gear that is connected to a main drive shaft that supports and extends between the first drive members, whereby rotation of the main drive shaft is translated into rotation of the vertical shaft through the first and second drive gears.

16. The slide-out mechanism of claim 15, wherein each of the second drive members comprises a toothed gear that meshes with the second drive features that are in the form of slots formed linearly in the second guide member.

17. The slide-out mechanism of claim 15, wherein the main drive shaft is operatively connected to a motor whose actuation is translated into rotation of the main drive shaft in one of two rotational directions.

18. The slide-out mechanism of claim 15, wherein the vertical shaft includes a pair of rollers that are disposed adjacent the second drive member and the first drive gear, one roller being in contact with the second guide member, while the other roller being in contact with the first guide member to facilitate movement of the slide-out section.

19. The slide-out mechanism of claim 15, wherein the main drive shaft includes at least two roller disposed adjacent the first drive members and being in contact with an underside of a floor of the slide-out section to facilitate sliding thereof.

20. The slide-out mechanism of claim 15, wherein the support member is a C-shaped bracket that at least partially surrounds the vertical shaft.

21. The slide-out mechanism of claim 1, wherein the drive mechanism includes an active drive assembly associated with one corner of the slide-out section and a passive assembly associated with an opposite corner of the slide-out section, the passive assembly being operatively connected to the active drive assembly so that drive action of the active assembly is translated to the passive assembly.

22. The slide-out mechanism of claim 1, wherein the drive mechanism includes (a) a transverse drive shaft with one of the first drive members being proximate one end of the transverse drive shaft and the other first drive member being proximate the other end of the transverse drive shaft; (b) a pair of first coupling gears disposed at the first and second ends of the transverse drive shaft; (c) a pair of vertical drive shafts disposed at the first and second ends of the transverse drive shaft, with each vertical drive shaft including a second coupling gear that mates with one first coupling gear so that rotation of the transverse drive shaft is imparted into rotation of the vertical drive shaft; and wherein the pair of second drive members are coupled to the vertical drive shafts and operatively engage the second guide members such that rotation of the vertical drive shafts is translated into axial movement of the second guide members resulting in the slide-out section being moved.

23. The slide-out mechanism of claim 1, wherein the drive mechanism is of a manual type requiring manual labor to cause the first drive members to successively engage the first drive features to cause controlled movement of the slide-out section.

24. The slide-out mechanism of claim 1, wherein the first drive members are toothed gears that are driven in a first direction to cause the slide-out section to extend and in a second direction to cause the slide-out section to retract.

25. The slide-out mechanism of claim 1, wherein the slide-out section is incorporated into one recreational vehicle selected from the group comprising: a fifth wheel trailer and a motor home or into a commercial eighteen wheel rig.

26. The slide-out mechanism of claim 1, wherein the second drive members are operatively coupled to the first drive members through intermeshing beveled gears that translate rotation of a horizontal drive shaft carrying the first drive members into rotation of vertical drive shafts changing the second drive members.

27. The slide-out mechanism of claim 1, wherein the first drive members rotate in planes perpendicular to planes in which the second drive members rotate.

28. A method for controllably moving a slide-out section, that is associated with a vehicle, between a retracted position and an extended position comprising the steps of:
coupling a pair of first guide members to the slide-out section, each of the first guide members having a plurality of first drive features formed as a part thereof;
coupling a pair of second guide members to opposing side walls of the slide-out section, each of the second guide members having a plurality of second drive features formed as a part thereof;
providing a drive mechanism that has a pair of first drive members that are complementary to the first drive features, the first drive members being disposed in a fixed location relative to the movable first guide members and a pair of second drive members that are operatively coupled to the first drive members such that rotation of the first drive members is translated into rotation of the second drive members;
engaging the first drive members to the first drive features and the second drive members to the second drive features; and
rotating the first drive members to cause them to engage successive first drive features to cause rotation of the second drive members which results in the second drive members engaging successive second drive features, thereby driving the second guide members, along with the first guide members, which results in the slide-out section being driven to one of an extended position and a retracted position.

29. The method of claim 28, wherein the step of coupling the first guide members comprises:
securely mounting the first guide members to an underside of a floor of the slide-out section.

30. The method of claim 28, wherein the drive mechanism is disposed underneath and to the sides of the slide-out section.

31. The method of claim 28, wherein the first drive members comprise first toothed sprockets that are axially fixed relative to the first guide members and the slide-out section and the step of rotating the first drive members comprises the steps of:
rotating a transverse drive shaft that carries the first sprockets such that the teeth of the first sprockets engage successive slots or ribs formed in the first guide members to drive the slide-out section.

32. The method of claim 31, wherein the second drive members comprise second toothed sprockets that are axially fixed relative to the second guide members and the slide-out section and the step of rotating the second drive members comprises the steps of:
rotating a pair of spaced vertical drive shaft that are operatively coupled to ends of the transverse drive shaft such that rotation of the transverse drive shaft is translated into rotation of the vertical drive shafts, the vertical drive shafts carrying the second sprockets such that the teeth of the second sprockets engage successive slots or ribs formed in the second guide members to drive the slide-out section.

33. A sliding mechanism for extending and retracting a slide-out section of a recreational vehicle having a support portion, the sliding mechanism comprising:
a first side assembly comprising a first track and a first gear assembly;
a second side assembly comprising a second track and a second gear assembly; and
a drive shaft connecting the first gear assembly and the second gear assembly;
wherein the first track and the second track are coupled to the slide-out section, the first track and the second track being configured to allow the slide-out section to move relative to the first gear assembly and the second gear assembly as a result of the first gear assembly and the second gear assembly being configured to drivingly engage the first track and the second track so as to extend or retract the slide-out section.

34. A sliding mechanism for extending and retracting a slide-out section of a recreational vehicle having a support portion, the sliding mechanism comprising:
a frame assembly mounted to the support portion;
an upper track coupled to an upper portion of the slide-out section; the upper track being configured to allow the slide-out section to move relative to the frame assembly;
an upper gear assembly mounted in the frame assembly and configured to drivingly engage the upper track so as to extend or retract the slide-out section;
a lower track disposed on a lower portion of the slide-out section; the lower track being configured to allow the slide-out section to move relative to the frame assembly;
a lower gear assembly mounted in the frame assembly and configured to drivingly engage the lower track so as to extend or retract the slide-out section; and
wherein the upper gear assembly and said lower gear assembly are powered by a single drive mechanism.

35. The sliding mechanism from claim 34, wherein the upper and lower tracks are substantially perpendicular to one another.
